(19) United States
(12) Patent Application Publication
(10) Pub. No.: US 2026/0349446 A1
(43) Pub. Date: Nov. 5, 2026

(54) DEVICE AND METHOD FOR AUTOMATICALLY CALLING A MOBILE ROBOT BASED ON A USER IMAGE

(71) Applicants: Hyundai Motor Company, Seoul (KR); Kia Corporation, Seoul (KR)

(72) Inventors: Changyo Lee, Hwaseong-si (KR); Hyunjun Jang, Hwaseong-si (KR)

(21) Appl. No.: 19/741,438

(22) Filed: Jul. 14, 2026

Related U.S. Application Data
(63) Continuation-in-part of application No. 19/365,029, filed on Oct. 21, 2025.
Application No. 19/365,029 is a continuation-in-part of application No. 19/098,058, filed on Apr. 2, 2025.

(30) Foreign Application Priority Data
Oct. 17, 2024 (KR) 10-2024-0142400
Aug. 19, 2025 (KR) 10-2025-0115327
Dec. 3, 2025 (KR) 10-2025-0188940

(51) Int. Cl. G05D 1/686; G05D 1/248; G06T 7/60; G06T 7/73; G06V 10/40; G06V 10/74; G06V 10/82; G06V 20/56; G06V 40/10

(52) U.S. Cl. CPC G05D 1/686; G05D 1/248; G06T 7/60; G06T 7/74; G06V 10/40; G06V 10/761; G06V 10/82; G06V 20/56; G06V 40/10; G06T 2207/20084; G06T 2207/30196; G06T 2207/30252

(57) ABSTRACT

In an embodiment a device includes a processor and a memory storing instructions that, when executed by the processor, enable the device to perform generating user image information through feature extraction of a user image, generating keyframe list information based on GPS information of a user mobile device and a keyframe database generated by a robot through mapping, determining similar keyframes having a similarity greater than or equal to a threshold between the user image information and the keyframe list information, determining candidate keyframes from the similar key frames, the candidate keyframes having geometrically similar co-relationships with the user image information, generating user position estimation information based on co-relationships of 3D point information of the determined candidate keyframes and 2D point information of the user image information, and controlling the robot to move to an estimated user position based on the user position estimation information.

### CROSS-REFERENCE TO RELATED APPLICATIONS

This application is a Continuation-in-Part application of U.S. Application No. 19/365,029, filed Oct. 21, 2025, which is a Continuation-in-Part application of U.S. Application No. 19/098,058, filed Apr. 2, 2025, which claims priority to Korean Patent Application No. 10-2024-0142400, filed Oct. 17, 2024, and further claims priority to Korean Patent Application No. 10-2025-0115327 filed with the Korean Intellectual Property Office on Aug. 19, 2025, and further claims priority to Korean Patent Application No. 10-2025-0188940 filed with the Korean Intellectual Property Office on Dec. 3, 2025, and which applications are incorporated herein by reference in their entireties.

### TECHNICAL FIELD

The present disclosure relates to a device and method for automatically calling a mobile robot based on a user image, and more particularly, the present disclosure relates to a device and method for automatically calling a mobile robot based on a user image that summons the robot to a current position of the user based on an image data obtained by a mobile robot and an image transmitted from a user terminal.

### BACKGROUND

The smart summon feature is being extensively studied in autonomous driving vehicles. In particular, it is a function that allows the vehicle to find the user by using the GPS of the user without the user having to go directly to the vehicle by using static map information and vehicle sensor data information.

The most studied area is smart summon using GPS in the automotive industry, and most of the problems are not estimating the user's location, but driving problems using current sensor data and static maps are mostly dealt with. In the case of robots, in a current smart summoning, calls are made through QR markers and designated physical buttons.

Conventional technologies are fundamentally dependent on GPS and are limited to automotive platforms. In addition, for mobile robots that navigate indoors and outdoors, GPS and static maps are insufficient, and QR markers and physical devices are too limited to address all common call situations.

### SUMMARY

Embodiments of the present disclosure attempt to provide a device and method for automatically calling a mobile robot based on a user image that can follow a current position of the user based on GPS and vision data transmitted from a user terminal and image data obtained by the robot, and summon the robot to the followed current position of the user.

Embodiments provide a device for automatically calling a mobile robot based on a user image. The device may include one or more non-transitory computer-readable media including an instruction, and one or more processors configured to perform an operation by executing the instruction, where the operation may include generating current user image information through feature extraction of the user image, generating keyframe list information based on GPS information of a user mobile device and a keyframe database generated by a robot through mapping, determining similar keyframes having a similarity greater than or equal to a threshold between the user image information and the keyframe list information, determining candidate keyframes having a geometrically similar co-relationship with the user image information from among the similar keyframes, and generating user position estimation information based on a co-relationship of 3D point information of the determined candidate keyframes and 2D point information of the user image information.

The operation may further include receiving the user image and a summoning command correspond to a current position of the user from the user mobile device, transmitting the summoning command together with the user image to the robot, and transmitting the user position estimation information generated based on the user image information and the keyframe information to the robot in stand-by.

The generating of the current user image information through feature extraction of the user image may include extracting a feature of the user image and generate a query frame by using an image feature extraction algorithm including a neural vector of locally aggregated descriptors (NetVLAD).

The generating of the keyframe list information based on the GPS information of the user mobile device and the keyframe database generated by the robot through mapping may include determining a reliability of the GPS information of the user mobile device, collecting all environment data within a specific (or predefined) range based on the GPS information, when the reliability is less than a reference, and collecting only the keyframe data within the specific range based on the GPS information, when the reliability is greater than or equal to a reference.

The generating of the keyframe list information based on the GPS information of the user mobile device and the keyframe database generated by the robot through mapping may include checking whether the keyframe data within the GPS information-based specific range exists within the keyframe database, generating the keyframe list information, when the keyframe data within the GPS information-based specific range exists within the keyframe database, and declaring a failure on generation of the user position estimation information, when the keyframe data within the GPS information-based specific range does not exist within the keyframe database.

The determining of the similar keyframes having a similarity greater than or equal to the threshold between the user image information and the keyframe list information may include determining N similar keyframes having highest similarities by calculating a cosine similarity between a query frame in which the extracted feature of the user image information is stored and the keyframe list information.

The determining of the candidate keyframes having the geometrically similar co-relationship with the user image information from among the similar keyframes may include performing a RANSAC(RANdom SAmple Consensus)-based geometric verification based on feature point matching information between the user image information and the similar keyframes, to generate a candidate keyframe group including only keyframes geometrically most similar to the user image information among the similar keyframes.

The determining of the candidate keyframes having the geometrically similar co-relationship with the user image information from among the similar keyframes may include obtaining a fundamental matrix based on the feature point matching information, detecting an inlier for a feature of a query frame of the user image information and a feature of a specific candidate keyframe of the candidate keyframe group, based on the obtained fundamental matrix information, and excluding the specific candidate keyframe from the candidate keyframe group, when the number of the detected inliers is less than or equal to a reference value.

The generating of the user position estimation information based on the co-relationship of the 3D point information of the determined candidate keyframes and the 2D point information of the user image information may include detecting 3D map point information with respect to a second 2D feature point of the candidate keyframe matched with a first 2D feature point of the user image information from an image map within the keyframe database, and generating a 3D-2D pair based on the first 2D feature point and the 3D point map information.

The generating of the user position estimation information based on co-relationship of the 3D point information of the determined candidate keyframes and the 2D point information of the user image information may include extracting a candidate position of the user within a spatial coordinate system according to the user image information by using a perspective n point algorithm with an input of the 3D-2D pair, and finally generating the user position estimation information by optimizing the candidate position by using a local bundle adjustment.

Embodiments provide a method for automatically calling a mobile robot based on a user image, which is performed by a computing device including a processor and a memory. The method may include generating current user image information through feature extraction of the user image, by the processor, generating keyframe list information based on GPS information of a user mobile device and a keyframe database generated by the robot through mapping, by the processor, determining similar keyframes having a similarity greater than or equal to a threshold between the user image information and the keyframe list information, by the processor, determining candidate keyframes having a geometrically similar co-relationship with the user image information from among the similar keyframes, by the processor, and generating user position estimation information based on a co-relationship of 3D point information of the determined candidate keyframes and 2D point information of the user image information, by the processor.

The method may further include receiving the user image and a summoning command correspond to a current position of the user from the user mobile device, by the processor, transmitting the summoning command together with the user image to the robot, by the processor, and transmitting the user position estimation information generated based on the user image information and the keyframe information to the robot in stand-by, by the processor.

The generating of the current user image information through feature extraction of the user image may include extracting a feature of the user image and generate a query frame by using an image feature extraction algorithm including a neural vector of locally aggregated descriptors (NetVLAD).

The generating of the keyframe list information based on the GPS information of the user mobile device and the keyframe database generated by the robot through mapping may include determining a reliability of the GPS information of the user mobile device, collecting all environment data within a specific range based on the GPS information, when the reliability is less than a reference, and collecting only the keyframe data within the specific range based on the GPS information, when the reliability is greater than or equal to a reference.

The generating of the keyframe list information based on the GPS information of the user mobile device and the keyframe database generated by the robot through mapping may include checking whether the keyframe data within the GPS information-based specific range exists within the keyframe database, generating the keyframe list information, when the keyframe data within the GPS information-based specific range exists within the keyframe database, and declaring a failure on generation of the user position estimation information, when the keyframe data within the GPS information-based specific range does not exist within the keyframe database.

The determining of the similar keyframes having a similarity greater than or equal to the threshold between the user image information and the keyframe list information may include determining N similar keyframes having highest similarities by calculating a cosine similarity between a query frame in which the extracted feature of the user image information is stored and the keyframe list information.

The determining of the candidate keyframes having the geometrically similar co-relationship with the user image information from among the similar keyframes may include performing a RANSAC-based geometric verification based on feature point matching information between the user image information and the similar keyframes, to generate a candidate keyframe group including only keyframes geometrically most similar to the user image information among the similar keyframes.

The determining of the candidate keyframes having the geometrically similar co-relationship with the user image information from among the similar keyframes may include obtaining a fundamental matrix based on the feature point matching information, detecting an inlier for a feature of a query frame of the user image information and a feature of a specific candidate keyframe of the candidate keyframe group, based on the obtained fundamental matrix information, and excluding the specific candidate keyframe from the candidate keyframe group, when the number of the detected inliers is less than or equal to a reference value.

The generating of the user position estimation information based on co-relationship of the 3D point information of the determined candidate keyframes and the 2D point information of the user image information may include extracting a candidate position of the user according to a candidate position of the user by using a perspective n point algorithm, and finally generating the user position estimation information by using local bundle adjustment based on the candidate position.

Embodiments provide one or more non-transitory computer-readable media including an instruction executable by a computing a device is provided, where the instruction causes the computing device to perform an operation, when executed by one or more processors of the computing the device, and where the operation may include generating current user image information through feature extraction of a user image, generating keyframe list information based on GPS information of a user mobile device and a keyframe database generated by a robot through mapping, determining similar keyframes having a similarity greater than or equal to a threshold between the user image information and the keyframe list information, determining candidate keyframes having a geometrically similar co-relationship with the user image information from among the similar keyframes, and generating user position estimation information based on a co-relationship of 3D point information of the determined candidate keyframes and 2D point information of the user image information.

A device and method for automatically calling a mobile robot based on a user image according to an embodiment of the present disclosure may follow the current position of the user based on GPS and vision data transmitted from a user terminal and image data obtained by the robot, and summon the robot to the followed current position of the user.

### BRIEF DESCRIPTION OF THE DRAWINGS

FIG. 1 schematically shows a system for automatically calling a mobile robot based on a user image according to an embodiment of the present disclosure.

FIG. 2 is a block diagram of a device for automatically calling a mobile robot based on a user image according to an embodiment of the present disclosure.

FIG. 3 is a drawing for explaining an operation of a device for automatically calling a mobile robot based on a user image according to an embodiment of the present disclosure.

FIG. 4 is a flowchart of a method for automatically calling a mobile robot based on a user image according to an embodiment of the present disclosure.

FIG. 5 is a flowchart of a method for automatically calling a mobile robot based on a user image according to an embodiment of the present disclosure.

FIG. 6 is a drawing for explaining a computing device according to an embodiment of the present disclosure.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to distinguish one component from another.

In addition, the terms “unit”, “part” or “portion”, “-er”, and “module” in the specification refer to a unit that processes at least one function or operation, which may be implemented by hardware, software, or a combination of hardware and software.

In addition, at least some components and features of a device and method for automatically calling a mobile robot based on a user image according to embodiments described below may be implemented as a program or software, and the program or software may be stored in a computer-readable medium.

Hereinafter, embodiments of the present disclosure will be described with reference to the drawings.

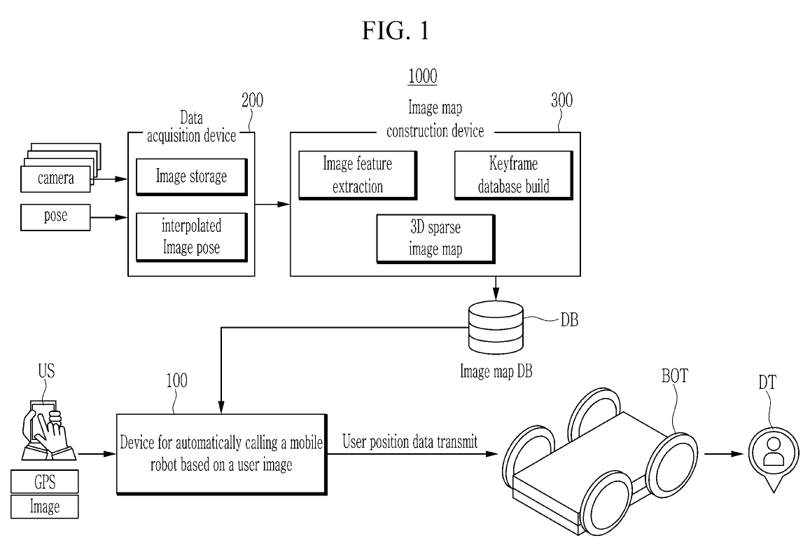

FIG. 1 schematically shows a system for automatically calling a mobile robot based on a user image according to an embodiment of the present disclosure.

Referring to FIG. 1, a system 1000 for automatically calling a mobile robot based on a user image may include a device 100 for automatically calling a mobile robot based on a user image, a data acquisition device 200, an image map construction device 300, a user mobile device US, a robot BOT and a database DB.

The user mobile device US may be a terminal equipment that the user uses, such as a mobile phone.

The user may transmit user image information and GPS information corresponding to a current a position of the user to the device 100 for automatically calling a mobile robot based on a user image through the user mobile device US.

The robot BOT is a mobile robot, and may correspond to all robots that is drivable by using wheels or quadrupedal walking.

First, the data acquisition device 200 may obtain image data and robot pose data obtained by a camera, from the robot driven in a service area.

The data acquisition device 200 may wait for a data acquired status for an update of the image map from a control server.

In addition, when a data acquisition event occurs, the data acquisition device 200 obtains the position information (or image pose data) of the image synchronized with the position of the robot through position information of the robot and the robot-centered camera external parameters.

That is, since temporal synchronization between robot position information and image information is not made, the data acquisition device 200 may follow an image position information by utilizing the Unix time information of the robot position information and the Unix time information of the obtained image, and at the same time, store the image and the position information (interpolated Image pose) of the image.

The data acquisition device 200 may store a target image in a JPEG format.

The data acquisition device 200 may store the image pose data correspond to the target image in a text format.

The data acquisition device 200 may also store temporal information (e.g., a Unix time) of the target image together, to accurately match the target image and the image pose data.

The image map construction device 300 may construct a 3D image map and a keyframe database based on the image data and the robot pose data obtained in the service area.

The image map construction device 300 may generate the keyframe database based on image comprehensive information obtained from the data acquisition device 200.

In more detail, the image map construction device 300 may perform feature point extraction from the keyframe, based on having performed data acquisition.

The image map construction device 300 may generate a target keyframe, by combining at least one of the image pose data, the robot pose data, the external parameters, or a combination thereof, to the target image stored in the memory.

The target keyframe may include pixels of the target image, and the pose of the camera (i.e., the image pose data) at the time point to obtain the target image. For example, the keyframe may represent the image at a specific time point used to represent the position or environment of the robot. Here, the keyframe may include the image, the image pose data, and the robot pose data. Specifically, the target keyframe may include at least one of the target image, the position (e.g., the image pose data) of the target image, the robot pose data (e.g., roll, pitch, yaw of the robot), external parameters, or a combination thereof.

The image map construction device 300 may extract at least one feature from the target keyframe.

The image map construction device 300 may apply the target keyframe to a first feature extraction model that extracts the feature with respect to the point of the object, to obtain first data related to the point feature of the object included in the keyframe.

For example, the first feature extraction model may represent a model performing a scale-invariant feature transform (SIFT) algorithm or speeded up robust features (SURF) algorithm. The first data may include a target of which the feature with respect to the point of the object is represented in 128 dimensional vector.

The image map construction device 300 may apply the target keyframe to a second feature extraction model that extracts the feature with respect to the line of the object, to obtain second data related to the line feature of the object included in the keyframe. For example, the second feature extraction model may represent a model that extracts a line feature, which is a structure such as a straight line or a curved line within the image. The second data may include a target of which the feature with respect to the line of the object is represented in 64 dimensional vector.

The image map construction device 300 may apply the target keyframe to a third feature extraction model extracting a global feature related to an object disposal or color distribution, to obtain third data related to the global feature of the keyframe. The third feature extraction model may represent a model performing a net-vector of locally aggregated descriptors (NetVLAD) related to deep learning-based feature extraction and descriptor generation. The third data may include a target of which 512 individual local descriptors and each local descriptor is represented in 64 dimensions.

The image map construction device 300 may store the target keyframe, the first data, the second data, and the third data in the keyframe database DB.

That is, the image map construction device 300 may store the image data in the generated database DB, and extract the keyframe image feature point.

The image map construction device 300 may extract and store the feature point of the image of the keyframe by using a model extracting points/lines/global features.

For example, the feature extraction model may include a scale-invariant feature transform (SIFT) model and/or a net-vector of locally aggregated descriptors (NetVLAD) model.

The image map construction device 300 may group 20 keyframe data having high similarity between respective keyframes and store matching information, by using a cosine distance based on a global descriptor between the stored keyframes.

The image map construction device 300 may store the feature point and the camera external/internal parameter of the image of each keyframe, the image position information, similar keyframe group information, and image matching feature points in the database DB.

That is, the image map construction device 300 may group similar keyframes with respect to all keyframes through the cosine distance based on an image global descriptor between the keyframes.

At this time, the image map construction device 300 may sort only the keyframe having a highest cosine similarity, and store similar keyframes by grouping them into groups of, for example, 20 for each keyframe.

The image map construction device 300 may extract the 2D feature point matching information between similar keyframe groups through a 2D feature point (point feature) matching model (e.g., fast library for approximate nearest neighbors (FLANN)), and store it in the database DB.

For example, the image map construction device 300 may compare the 2D feature points between the keyframes included in the target group, to identify how features generated from the same object or structure correspond.

The 2D feature point may represent a specific point that can easily recognized from the image, and compared across multiple images. For example, the 2D feature point may be extracted from corner, edge, or texture included in the image.

In more detail, the image map construction device 300 may identify the first keyframe and the second keyframe among the keyframes included in the target group.

The image map construction device 300 may perform the 2D feature point matching, based on the fact that the 2D feature point included in the first keyframe and the 2D feature point included in the second keyframe correspond to the same target in the target space.

As an example, when the 2D feature point included in the first keyframe and the 2D feature point included in the second keyframe corresponds to a part of an object (e.g., wall or corner, or the like) existing in the target space, the image map construction device 300 may match the 2D feature point included in the first keyframe and the 2D feature point included in the second keyframe.

The image map construction device 300 may generate the 3D image map (3D sparse image map) based on the stored keyframe database and the similar keyframe group information.

The image map construction device 300 may extract 3D points by using the image position information and image feature points between the keyframe similarity groups.

That is, the image map construction device 300 may generate 2D image feature points through 3D triangulation on the 3D space as points through the obtained keyframe database DB (which stores 2D point matching information between similar keyframe group and the keyframe, camera internal parameter information, the image position information).

The image map construction device 300 may generate the feature points of the image on a 3-dimensional space, and construct an initial 3D image map.

The image map construction device 300 may simultaneously optimize the 3D point maps and obtain an optimal 3D image map, by using an optimization method (e.g., a global bundle adjustment) based on 2D feature point information between all keyframes mapped with initial 3D map points.

The database DB may store the generated image map and the keyframe information. That is, the database DB may be referred to as the image map database or the keyframe database.

The device 100 for automatically calling a mobile robot based on a user image may estimate the position of the user by using the 3D image map, the keyframe database, the GPS information transmitted by a user US, and/or the user image.

The device 100 for automatically calling a mobile robot based on a user image may summon a mobile robot BOT to the estimated user position.

The device 100 for automatically calling a mobile robot based on a user image may estimate the position information of the user image received from the user US based on the image map and the keyframe data within the database DB, to consider the estimated position information of the user image as a user's position DT and transmit it to the robot BOT.

The device 100 for automatically calling a mobile robot based on a user image may receive a user image and a summoning command correspond to the current position of the user from the user mobile device US.

The device 100 for automatically calling a mobile robot based on a user image may transmit summoning command together with the user image to the robot BOT.

Afterwards, the device 100 for automatically calling a mobile robot based on a user image may generate the user position estimation information DT based on the user image information and the keyframe information, and transmit it to the robot BOT in stand-by.

The device 100 for automatically calling a mobile robot based on a user image may be disposed inside or outside the robot BOT.

The device 100 for automatically calling a mobile robot based on a user image may be connected to the user mobile device US and the robot BOT through a wired/wireless network.

The robot BOT may set the destination through the user position estimation information DT, and drive to the destination according to the summoning command.

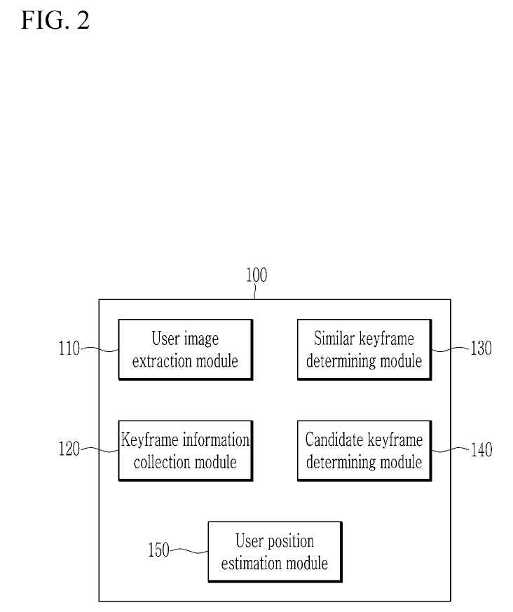

FIG. 2 is a block diagram of a device for automatically calling a mobile robot based on a user image according to an embodiment of the present disclosure.

The device 100 for automatically calling a mobile robot based on a user image according to an embodiment may be implemented as a computing device including a processor and a memory.

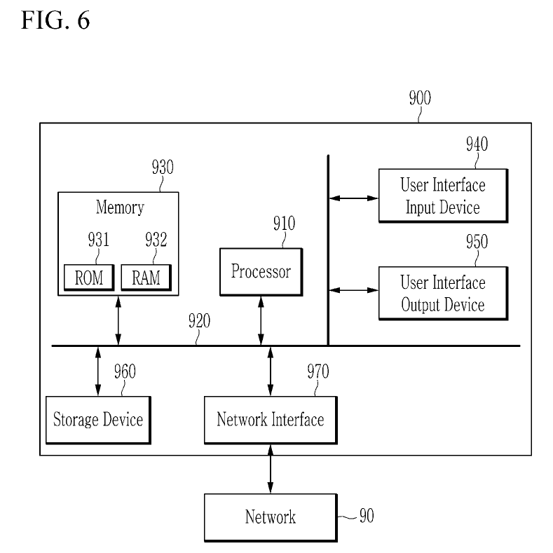

For example, the device 100 for automatically calling a mobile robot based on a user image may be implemented as a computing device 900 described later with reference to FIG. 6. In this case, the processor may correspond to a processor 910 of the computing device 900, and the memory may correspond to a memory 930 of the computing device 900.

Alternatively, in some embodiments, the device 100 for automatically calling a mobile robot based on a user image may include one or more non-transitory computer-readable media including an instruction and one or more processors configured to perform an operation by executing the instruction. Here, the operation may include a configuration, a function, a step, or the like, described in this specification with respect to a device and method for automatically calling a mobile robot based on a user image according to embodiments.

In this specification, the term “module” is used in order to logically differentiate these operations performed by a device and method for automatically calling a mobile robot based on a user image according to embodiments.

Referring to FIG. 2, the device 100 for automatically calling a mobile robot based on a user image may include a user image extraction module 110, the keyframe information collection module 120, a similar keyframe determining module 130, a candidate keyframe determining module 140 and a user position estimation module 150.

The user image extraction module 110 may generate current user image information through feature extraction of the user image.

The user image extraction module 110 may extract a feature of the user image and generate a query frame by using an image feature extraction algorithm including a neural vector of locally aggregated descriptors (NetVLAD).

The query frame may be a frame of a query image of the user image.

The keyframe information collection module 120 may generate the keyframe list information based on the keyframe database generated through mapping by the GPS information of the user mobile device and the robot.

The keyframe information collection module 120 may determine the reliability of the GPS information of the user mobile device.

When the reliability is less than a reference, the keyframe information collection module 120 may collect all environment data within a specific range based on the GPS information.

When the reliability is greater than or equal to a reference, the keyframe information collection module 120 may collect only the keyframe data within the specific range based on the GPS information.

The above reference may be a preset value based on the signal strength or stability of the user's GPS.

The keyframe information collection module 120 may check whether the keyframe data within a GPS information-based specific range exists within the keyframe database DB (see FIG. 1).

When the keyframe data within the specific range exists, the keyframe information collection module 120 may generate the keyframe list information.

When the keyframe data within the specific range does not exist, the keyframe information collection module 120 may declare the failure of generating of the user position estimation information.

The similar keyframe determining module 130 may determine similar keyframes having a keyframe similarity greater than or equal to a threshold between the user image information and the keyframe list information.

The similar keyframe determining module 130 may determine N similar keyframes having highest similarities by calculating the cosine similarity between the query frame in which the extracted feature of the user image information is stored and the keyframe list information.

The candidate keyframe determining module 140 may determine candidate keyframes having a geometrically similar co-relationship with the user image information from among the similar keyframes.

Geometric co-relationship may refer to a state where the location, shape, viewpoint, and structural arrangement of objects within two images match or are very similar, going beyond mere similarity in color between the two images.

The candidate keyframe determining module 140 may perform a RANSAC-based geometric verification based on the feature point matching information between the user image information and the similar keyframes, to generate a candidate keyframe group including only keyframes geometrically most similar to the user image information (the query frame) among the similar keyframes.

The candidate keyframe determining module 140 may obtain a fundamental matrix based on the feature point matching information.

The candidate keyframe determining module 140 may detect an inlier for a feature of the query frame of the user image information and a feature of a specific candidate keyframe of the candidate keyframe group, based on the obtained fundamental matrix information.

When the number of the detected inliers is less than or equal to reference value, the candidate keyframe determining module 140 may exclude the specific candidate keyframe from the candidate keyframe group.

The user position estimation module 150 may generate the user position estimation information based on a co-relationship of 3D point information of the determined candidate keyframes and 2D point information of the user image information.

The user position estimation module 150 may detect 3D map point information with respect to a second 2D feature point of the candidate keyframe matched with a first 2D feature point of the user image information in the image map within the keyframe database.

The user position estimation module 150 may generate a 3D-2D pair based on a 3D point map information with respect to the first 2D feature point and the second 2D feature point.

The user position estimation module 150 may extract a candidate position of the user according to a candidate position of the user by using a perspective n point algorithm with an input of the 3D-2D pair.

The user position estimation module 150 may finally generate the user position estimation information by using a local bundle adjustment based on the candidate position.

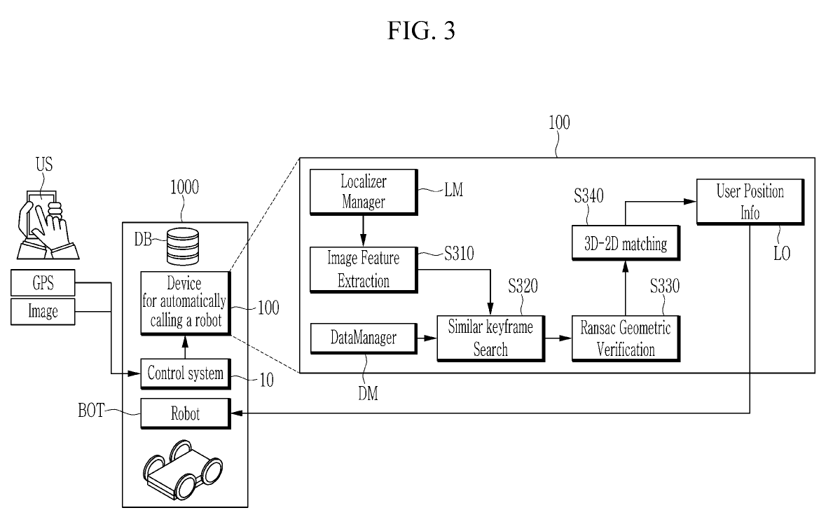

FIG. 3 is a drawing for explaining an operation of a device for automatically calling a mobile robot based on a user image (hereinafter, a device for automatically calling a robot) according to an embodiment of the present disclosure.

In FIG. 3, the system 1000 for automatically calling a mobile robot based on a user image according to an embodiment may include the keyframe database DB, the device 100 for automatically calling a robot, a control system 10 and the robot BOT.

The control system 10 may receive the user GPS information and the user image information from the user mobile device US.

When a robot summoning command including the user GPS information and the user image information is received from the user mobile device US, the control system 10 may issue a command to the device 100 for automatically calling a robot to perform an operation for an automatic summon of the robot.

The device 100 for automatically calling a robot may estimate the current position of the user by using the keyframe database DB, the user GPS information and the user image information, and may transmit the corresponding position to the robot BOT to command driving to the corresponding position.

In an embodiment, when the robot BOT receives a summon from the control system 10, an execution command of a robot summon operation is transferred to the device 100 for automatically calling a robot through a localizer manager LM.

When the robot summon event is transferred through the localizer manager LM, the device 100 for automatically calling a robot may extract the feature point from the current user image information, to generate and store the query frame, at step S310.

The device 100 for automatically calling a robot may perform the keyframe similarity search through a data manager DM with respect to the query frame of which image features are stored, at step S320.

For example, the device 100 for automatically calling a robot may extract 10 keyframes of images most similar to a current user image based on the cosine distance from the database DB.

The device 100 for automatically calling a robot may remove remaining keyframes excluding the geometrically most similar keyframe through RANSAC geometric verification using the feature point between the keyframes similar to the query frame, at step S330.

The device 100 for automatically calling a robot may generate the keyframe candidate group including the most similar keyframes that remain after removing the remaining keyframes.

The device 100 for automatically calling a robot may obtain the image position information of the query frame by using the perspective n point algorithm and the local bundle adjustment based on a 3D image point of an image feature of the keyframe candidate group matched with an image feature of the query frame, at step S340.

That is, in order to estimate where the user image has been photographed (i.e., estimate a 3D position/pose of the camera), the device 100 for automatically calling a robot may calculate a precise position candidate group by the Perspective-n-Point (PnP) algorithm and bundle adjustment (BA) by using the co-relationship with respect to the already stored candidate keyframes.

The device 100 for automatically calling a robot may output the rotation R and movement t of the camera in response to an input of a 3D map point (X, Y, Z) obtained from the candidate keyframes through the Perspective-n-Point (PnP) algorithm, the 2D feature point (u, v) matched in the current user image, and the camera internal parameter. That is, the 6-degree-of-freedom position pose (camera pose) of the current user image may be output.

The device 100 for automatically calling a robot may minimize a reprojection error between a corresponding 3D point and 2D feature point, by using the PnP result (R, t) as an initial value through bundle adjustment (BA). That is, the pose, scale, or the like of the camera can be locally optimized.

The robot automatic calling device (100) may repeatedly apply the inliers to the candidate keyframes in the sequence of higher number of inliers, and determine one location with the lowest error or highest reliability as a final user image location.

The device 100 for automatically calling a robot may transmit the obtained user image position information LO to the robot BOT as the destination. Afterwards, the robot BOT may drive to the corresponding position where the current user exists through autonomous driving.

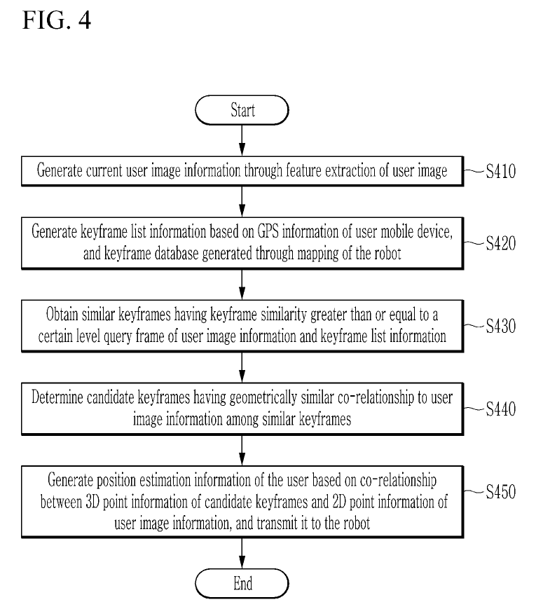

FIG. 4 is a flowchart of a method for automatically calling a mobile robot based on a user image according to an embodiment of the present disclosure. A method for automatically calling a mobile robot based on a user image of FIG. 4 may be performed through the device 100 for automatically calling a mobile robot based on a user image of FIG. 1.

In FIG. 4, the device 100 for automatically calling a mobile robot based on a user image may generate the current user image information through feature extraction of the user image, at step S410.

The device 100 for automatically calling a mobile robot based on a user image may generate the keyframe list information based on the GPS information of the user mobile device and the keyframe database generated by the robot through mapping, at step S420.

The device 100 for automatically calling a mobile robot based on a user image may obtain the similar keyframes having a keyframe similarity greater than or equal to the threshold between the query frame of the user image information and the keyframe list information, at step S430.

In an embodiment, the device 100 for automatically calling a mobile robot based on an image may measure the similarity between the keyframes.

The device 100 for automatically calling a mobile robot based on a user image may identify at least one keyframe from the keyframe database.

For example, the device 100 for automatically calling a mobile robot based on a user image may measure the similarity between the keyframes. The device 100 for automatically calling a mobile robot based on a user image may store the keyframes having high similarity as one group. Hereinafter, a method for generating one group by the device 100 for automatically calling a mobile robot based on a user image will be described in detail.

The device 100 for automatically calling a mobile robot based on a user image may perform grouping of the keyframes based on similarity. For example, the device 100 for automatically calling a mobile robot based on a user image may calculate similarity of each of the keyframes, based on the image feature points extracted from the keyframe, to generate a group including most similar 20 keyframes. During this process, a similarity between the keyframes by using the cosine similarity may be obtained.

The device 100 for automatically calling a mobile robot based on a user image may obtain at least one sub-keyframe, from the keyframe database. The at least one sub-keyframe may include keyframes generated from an image obtained at a time point prior to the target time point.

The device 100 for automatically calling a mobile robot based on a user image may determine the cosine similarity between the global feature of the target keyframe, and the global feature of each of the at least one sub-keyframe.

For example, the global feature of the target keyframe may represent the third data of the target keyframe. Specifically, the global feature may include an overall feature of the keyframe, as the feature extracted from the keyframe (e.g., global descriptor).

The global feature may include a target of which the feature extracted from the keyframe is represented as a 4096 dimensional vector.

The device 100 for automatically calling a mobile robot based on a user image may determine the cosine similarity between the global features of each of the at least one sub-keyframe and the global feature of the target keyframe.

For example, when the number of the at least one sub-keyframe is 3, the device 100 for automatically calling a mobile robot based on a user image may determine a first cosine similarity which is a similarity between the global feature of the target keyframe and a global feature of a first sub-keyframe, a second cosine similarity which is a similarity between the global feature of the target keyframe and a global feature of a second sub-keyframe, and a third cosine similarity which is a similarity between the global feature of the target keyframe and a global feature of a third sub-keyframe.

The cosine similarity may represent a value obtained by calculating an angle between two vectors, and measuring how similar two vectors are.

For example, the angle between two vectors may represent a between a first vector related to the global feature of the target keyframe and a second vector related to the global feature of one sub-keyframe among the at least one sub-keyframe, in a space in which the global feature is represented. Additionally, the angle between two vectors is not limited thereto.

For example, the angle between two vectors may represent an angle between a first vector related to the feature with respect to the point of the object of the target keyframe or the feature with respect to the line of the object and a second vector related to the feature with respect to the point of the object or the feature with respect to the line of the object of one sub-keyframe among the at least one sub-keyframe.

The device 100 for automatically calling a mobile robot based on a user image may sort the keyframes according to the similarity, based on the cosine similarity.

Thereafter, the device 100 for automatically calling a mobile robot based on a user image may select keyframes that are most similar (e.g., sub-keyframes having high similarity to the target keyframe), and may set and/or generate a group from these similar keyframes.

For example, the device 100 for automatically calling a mobile robot based on a user image may select most similar 20 keyframes, to generate one group.

The device 100 for automatically calling a mobile robot based on a user image may determine sub-keyframes in which the cosine similarity of each of the at least one sub-keyframe corresponds to a predetermined score, and generate a target group including the determined sub-keyframes and the target keyframe.

The device 100 for automatically calling a mobile robot based on a user image may perform the 2D feature point matching between the keyframes included in the target group, based on a fast library for approximate nearest neighbors (FLANN) algorithm.

For example, the device 100 for automatically calling a mobile robot based on a user image may compare the 2D feature points between the keyframes included in the target group, to identify how features generated from the same object or structure correspond.

The 2D feature point may represent a specific point that can easily recognized from the image, and compared across multiple images. For example, the 2D feature point may be extracted from corner, edge, or texture included in the image.

In more detail, the device 100 for automatically calling a mobile robot based on a user image may identify the first keyframe and the second keyframe among the keyframes included in the target group.

The device 100 for automatically calling a mobile robot based on a user image may perform the 2D feature point matching, based on the fact that the 2D feature point included in the first keyframe and the 2D feature point included in the second keyframe correspond to the same target in the target space.

As an example, when the 2D feature point included in the first keyframe and the 2D feature point included in the second keyframe corresponds to a part of an object (e.g., wall or corner, or the like) existing in the target space, the device 100 for automatically calling a mobile robot based on a user image may match the 2D feature point included in the first keyframe and the 2D feature point included in the second keyframe.

The device 100 for automatically calling a mobile robot based on a user image may determine the candidate keyframes having the geometrically similar co-relationship with the user image information from among the similar keyframes, at step S440.

The device 100 for automatically calling a mobile robot based on a user image may generate position estimation information of the user based on the co-relationship between 3D point information of the candidate keyframes and 2D point information of the user image information, and transmit it to the robot, at step S450.

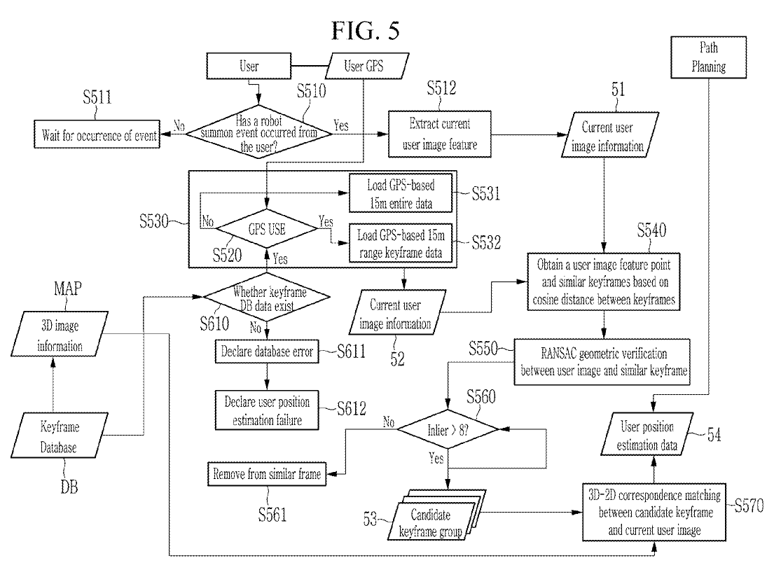

FIG. 5 is a flowchart of a method for automatically calling a mobile robot based on a user image according to an embodiment of the present disclosure. A method for automatically calling a mobile robot based on a user image of FIG. 5 may be performed through the device 100 for automatically calling a mobile robot based on a user image of FIG. 1.

In FIG. 5, the device 100 for automatically calling a mobile robot based on a user image may check when a robot summoning event from the user has occurred, at step S510, and when not occurred, may wait until an event occurs, at step S511.

When the robot summoning event occurs, the device 100 for automatically calling a mobile robot based on a user image may extract the feature of the current user image, to obtain current user image information 51, at step S512.

When an automatic robot summon command of the user and the user image is received from the user mobile device or the user terminal, the device 100 for automatically calling a mobile robot based on a user image may determine that the robot summoning event has occurred.

The device 100 for automatically calling a mobile robot based on a user image may extract a feature of the user image and generate the query frame including the current user image information 51 by using the image feature extraction algorithm including the neural vector of locally aggregated descriptors (NetVLAD).

The device 100 for automatically calling a mobile robot based on a user image may generate the keyframe list information 52 based on the GPS information of the user mobile device and the keyframe database DB generated by the robot through mapping, at step S530.

The device 100 for automatically calling a mobile robot based on a user image may determine the reliability of the user GPS information received from the user, at step S520.

The device 100 for automatically calling a mobile robot based on a user image may determine reliability based on the strength or stability of the signal of the user GPS.

When the reliability is less than a reference, the device 100 for automatically calling a mobile robot based on a user image may collect all environment data within the specific range based on the user GPS information, at step S531.

The reliability of GPS information is an indicator of how accurate and trustworthy (True) the location, speed, and time data provided by a GPS (Global Positioning System) receiver is.

When the reliability is greater than or equal to a reference, the device 100 for automatically calling a mobile robot based on a user image may collect only the keyframe data within the specific range based on the user GPS information, at step S532.

The device 100 for automatically calling a mobile robot based on a user image may check whether the keyframe data within the user GPS information-based specific range exists within the keyframe database DB, at step S610.

When the keyframe data exists, the device 100 for automatically calling a mobile robot based on a user image may generate the keyframe list information.

When the keyframe data does not exist, the device 100 for automatically calling a mobile robot based on a user image may declare a database error and a failure in generating of the user position estimation information, step S611 and step S612.

The device 100 for automatically calling a mobile robot based on a user image may calculate the cosine similarity between the query frame in which the extracted feature of the user image information 51 is stored and the keyframe list information 52, to obtain N similar keyframes having highest similarities, at step S540.

The device 100 for automatically calling a mobile robot based on a user image may perform the RANSAC-based geometric verification based on the feature point matching information between the user image information 51 and the similar keyframes, to generate a candidate keyframe group 53 including only keyframes geometrically most similar to the user image information 51 among the similar keyframes, at step S550.

The device 100 for automatically calling a mobile robot based on a user image may obtain the fundamental matrix based on the feature point matching information, and detect the inlier for the feature of the user image information 51 and the feature of the specific candidate keyframe of the candidate keyframe group 53, based on the obtained fundamental matrix information, at step S560.

When the number of the detected inliers is less than or equal to 8, which is the reference value, the device 100 for automatically calling a mobile robot based on a user image may exclude the specific candidate keyframe from the candidate keyframe group, at step S561.

That is, the device 100 for automatically calling a mobile robot based on a user image may detect the keyframe candidate group having a co-relationship geometrically similar to the query frame through the fundamental matrix (perspective transformation between two planes) between the current user image information 51 (hereinafter, referred to as query frame) and the similar keyframe.

The device 100 for automatically calling a mobile robot based on a user image may perform the 2D feature point matching (FLANN) with respect to similar keyframes for the query frame obtained through the keyframe similarity search.

That is, the device 100 for automatically calling a mobile robot based on a user image may use the feature point pairs obtained through the 2D feature point matching of the query frame and the similar keyframe when obtaining the fundamental matrix for determining geometric similarity relationship.

At this time, the device 100 for automatically calling a mobile robot based on a user image may obtain a geometrically fundamental matrix that is most similar based on the feature point pair, through an eight point algorithm and RANSAC.

The device 100 for automatically calling a mobile robot based on a user image may obtain the inlier based on the distance, to see how well the projection of the feature point between two images is made between the two planes through the obtained fundamental matrix information.

When the number of inliers is 8 or less, the device 100 for automatically calling a mobile robot based on a user image may remove that similar frame from the candidate keyframe group 53, since geometric similarity relationship cannot be established with respect to the query frame.

When the number of the detected inliers is greater than 8, the device 100 for automatically calling a mobile robot based on a user image may determine it as the candidate keyframe group 53.

The device 100 for automatically calling a mobile robot based on a user image may generate a 3D image map MAP through pose information of the robot and camera data.

That is, the image map MAP related to the service space may be generated based on the robot pose data and the image data. For example, the image map may represent a map in which the space in which the robot is located is digitally represented. Specifically, the image map may include a 3D sparse image map in which some important feature points in the space in which the robot is located are selectively represented, and a 3D high-density image map in which all surfaces, structures, objects, or the like of the space in which the robot is located are represented at high resolution.

The device 100 for automatically calling a mobile robot based on a user image may generate a user position estimation data 54 through 3D-2D correspondence matching between the candidate keyframe group 53 and the current user image information 51, at step S570.

That is, the device 100 for automatically calling a mobile robot based on a user image may generate the user position estimation data 54 through the 3D-2D correspondence matching by using the image map MAP and the candidate keyframe group 53.

The device 100 for automatically calling a mobile robot based on a user image may extract the candidate position of the user according to the candidate position of the user by using the perspective n point algorithm.

The device 100 for automatically calling a mobile robot based on a user image may finally generate the user position estimation data 54 by using the local bundle adjustment based on the candidate position.

The device 100 for automatically calling a mobile robot based on a user image may obtain a current image position information candidate through the co-relationship of 3D map points of the candidate keyframe and 2D points of the query frame by using the Perspective n Point algorithm and the bundle adjustment in the order of candidate keyframes having the largest number of previous inliers.

In more detail, the device 100 for automatically calling a mobile robot based on a user image may first search the 3D map points with respect to the 2D feature points of the candidate keyframe matched with the 2D feature points of the current user image information, in the image map MAP.

The device 100 for automatically calling a mobile robot based on a user image may generate a 2D (user image)-3D (matching candidate keyframe) pair based on the 2D feature point of the user image and the 3D point map information with respect to the 2D feature points of the candidate keyframe matched with that 2D feature point.

The device 100 for automatically calling a mobile robot based on a user image may extract candidate position information of each current user image to a space coordinate system through the Perspective n Point method based on a 2D-3D pair.

The device 100 for automatically calling a mobile robot based on a user image may finally optimize the position information through the local bundle adjustment with respect to the candidate position information of the extracted current image, and generate the user position estimation data 54.

The device 100 for automatically calling a mobile robot based on a user image may transmit the user position estimation data 54 to the robot, to use it in path planning of the robot.

FIG. 6 is a drawing for explaining the computing device according to an embodiment of the present disclosure.

Referring to FIG. 6, a device and method for automatically calling a mobile robot based on a user image according to embodiments may be implemented by using the computing device 900.

The computing device 900 may include at least one of the processor 910, the memory 930, a user interface input device 940, a user interface output device 950, and a storage device 960 that communicate through a bus 920. The computing device 900 may also include a network interface 970 electrically connected to a network 90. The network interface 970 may transmit or receive signal with other entities through the network 90.

The processor 910 may be implemented as various types of computational devices, for example, various types such as a micro controller unit (MCU), an application processor (AP), a central processing unit (CPU), a graphics processing unit (GPU), a neural processing unit (NPU), or the like, and may be any type of semiconductor device capable of executing instructions stored in the memory 930 or the storage device 960. The processor 910 may be configured to implement the functions and methods described above with reference to FIG. 1 to FIG. 5.

The memory 930 and the storage device 960 may include various types of volatile or non-volatile storage media. For example, memory may include a read-only memory (ROM) 931 and a random-access memory (RAM) 932. In the present embodiment, the memory 930 may be located inside or outside the processor 910, and the memory 930 may be connected to the processor 910 through already known various means.

The memory 930 may be connected to the processor 910 through various data buses or interfaces. This connection may be made through already known various means, for example, a Peripheral Component Interconnect Express (PCIe) interface for high-rate data transmission or a memory controller.

In some embodiments, at least some components and features of a device and method for automatically calling a mobile robot based on a user image according to embodiments may be implemented as a program or software executed by the computing device 900, and the program or software may be stored in a computer-readable medium.

In more detail, a computer-readable medium according to an embodiment may record a program for causing a computer including the processor 910 executing program or instruction stored in the memory 930 or the storage device 960 to execute steps included in an implementation of a device and method for automatically calling a mobile robot based on a user image according to embodiments.

In some embodiments, at least some components and features of a device and method for automatically calling a mobile robot based on a user image according to embodiments may be implemented using hardware or circuitry of the computing device 900, or may be implemented as separate hardware or circuitry that can be electrically connected to the computing device 900.

In some embodiments, one or more non-transitory computer-readable media that include an instruction executable by the computing device 900 are provided, and the instruction may cause the computing device 900 to perform the operation, when executed by one or more processors of the computing device 900. Here, the operation may include components, features, steps, or the like, described in this specification with respect to a device and method for automatically calling a mobile robot based on a user image according to embodiments.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of appended claims.

What is claimed is:

1. A device comprising:
a processor; and
a memory storing instructions that, when executed by the processor, enable the device to perform:
generating user image information through feature extraction of a user image;
generating keyframe list information based on GPS information of a user mobile device and a keyframe database generated by a robot through mapping;
determining similar keyframes having a similarity greater than or equal to a threshold between the user image information and the keyframe list information;
determining candidate keyframes from the similar key frames, the candidate keyframes having geometrically similar co-relationships with the user image information;
generating user position estimation information based on co-relationships of 3D point information of the determined candidate keyframes and 2D point information of the user image information; and
controlling the robot to move to an estimated user position based on the user position estimation information.

2. The device of claim 1, wherein the instructions further enable the device to perform:
receiving the user image and a summoning command correspond to a current position of a user from the user mobile device;
transmitting the summoning command together with the user image to the robot; and
transmitting the user position estimation information generated based on the user image information and the keyframe list information to the robot.

3. The device of claim 1, wherein generating the user image information comprises
extracting a feature of the user image and generate a query frame by using an image feature extraction algorithm comprising a neural vector of locally aggregated descriptors (NetVLAD).

4. The device of claim 1, wherein generating the keyframe list information based on the GPS information and the keyframe database comprises:
determining a reliability of the GPS information of the user mobile device;
collecting environment data within a specific range based on the GPS information, when the reliability is less than a reference; and
determining only keyframe data within the specific range based on the GPS information, when the reliability is greater than or equal to the reference.

5. The device of claim 4, wherein generating the keyframe list information based on the GPS information and the keyframe database comprises:
determining whether the keyframe data within the GPS information-based predetermined range exists within the keyframe database;
generating the keyframe list information, when the keyframe data within the GPS information-based predetermined range exists within the keyframe database; and
determining a failure on generating the user position estimation information, when the keyframe data within the GPS information-based predetermined range does not exist within the keyframe database.

6. The device of claim 1, wherein determining the similar keyframes having the similarity greater than or equal to the threshold comprises
determining N similar keyframes having highest similarities by calculating a cosine similarity between a query frame in which the extracted feature of the user image information is stored and the keyframe list information.

7. The device of claim 1, wherein determining the candidate keyframes from the similar keyframes comprises
performing a RANSAC(RANdom SAmple Consensus)-based geometric verification based on feature point matching information between the user image information and the similar keyframes, to generate a candidate keyframe group comprising only keyframes geometrically most similar to the user image information among the similar keyframes.

8. The device of claim 7, wherein determining the candidate keyframes from the similar keyframes comprises:
obtaining fundamental matrix information based on the feature point matching information;
determining, based on the obtained fundamental matrix information, an inlier for a feature of a query frame of the user image information and a feature of a specific candidate keyframe of the candidate keyframe group; and
excluding the specific candidate keyframe from the candidate keyframe group, when a number of the detected inliers is less than or equal to a reference value.

9. The device of claim 1, wherein generating the user position estimation information based on the co-relationships of the 3D point information of the determined candidate keyframes and the 2D point information of the user image information comprises:
determining 3D map point information with respect to a second 2D feature point of a candidate keyframe matched with a first 2D feature point of the user image information from an image map within the keyframe database; and
generating a 3D-2D pair based on the first 2D feature point and the 3D map point information.

10. The device of claim 9, wherein generating the user position estimation information based on the co-relationships of the 3D point information of the determined candidate keyframes and the 2D point information of the user image information comprises:
determining a candidate position of a user within a spatial coordinate system according to the user image information by using a perspective n point algorithm with an input of the 3D-2D pair; and
generating the user position estimation information by optimizing the candidate position by using a local bundle adjustment.

11. A method comprising:
generating, by a processor, user image information through feature extraction of a user image;
generating, by the processor, keyframe list information based on GPS information of a user mobile device and a keyframe database generated by a robot through mapping;
determining, by the processor, similar keyframes having a similarity greater than or equal to a threshold between the user image information and the keyframe list information;
determining, by the processor, candidate keyframes from the similar key frames, the candidate keyframes having geometrically similar co-relationships with the user image information;
generating, by the processor, user position estimation information based on co-relationships of 3D point information of the determined candidate keyframes and 2D point information of the user image information; and
controlling the robot to move to an estimated user position based on the user position estimation information.

12. The method of claim 11, further comprising:
receiving the user image and a summoning command correspond to a current position of a user from the user mobile device, by the processor;
transmitting the summoning command together with the user image to the robot, by the processor; and
transmitting the user position estimation information generated based on the user image information and the keyframe list information to the robot.

13. The method of claim 11, wherein generating the user image information comprises
extracting a feature of the user image and generate a query frame by using an image feature extraction algorithm comprising a neural vector of locally aggregated descriptors (NetVLAD).

14. The method of claim 11, wherein generating the keyframe list information based on the GPS information and the keyframe database comprises:
determining a reliability of the GPS information of the user mobile device;
collecting environment data within a specific range based on the GPS information, when the reliability is less than a reference; and
determining only keyframe data within the specific range based on the GPS information, when the reliability is greater than or equal to the reference.

15. The method of claim 14, wherein generating the keyframe list information based on the GPS information and the keyframe database comprises:
determining whether the keyframe data within the GPS information-based predetermined range exists within the keyframe database;
generating the keyframe list information, when the keyframe data within the GPS information-based predetermined range exists within the keyframe database; and
determining a failure on generating the user position estimation information, when the keyframe data within the GPS information-based predetermined range does not exist within the keyframe database.

16. The method of claim 11, wherein determining the similar keyframes having the similarity greater than or equal to the threshold comprises
determining N similar keyframes having highest similarities by calculating a cosine similarity between a query frame in which the extracted feature of the user image information is stored and the keyframe list information.

17. The method of claim 11, wherein determining the candidate keyframes from the similar keyframes comprises
performing a RANSAC-based geometric verification based on feature point matching information between the user image information and the similar keyframes, to generate a candidate keyframe group comprising only keyframes geometrically most similar to the user image information among the similar keyframes.

18. The method of claim 17, wherein determining the candidate keyframes from the similar keyframes comprises:
obtaining fundamental matrix information based on the feature point matching information;
determining, based on the obtained fundamental matrix information, an inlier for a feature of a query frame of the user image information and a feature of a specific candidate keyframe of the candidate keyframe group; and
excluding the specific candidate keyframe from the candidate keyframe group, when a number of the detected inliers is less than or equal to a reference value.

19. The method of claim 11, wherein generating the user position estimation information based on the co-relationships of the 3D point information of the determined candidate keyframes and the 2D point information of the user image information comprises:
determining a candidate position of a user according to the candidate position of the user by using a perspective n point algorithm; and
generating the user position estimation information by using local bundle adjustment based on the candidate position.

20. A non-transitory computer-readable medium having instructions stored thereon, wherein the instructions, when executed by a processor of a device, cause the device to perform:
generating user image information through feature extraction of a user image;
generating keyframe list information based on GPS information of a user mobile device and a keyframe database generated by a robot through mapping;
determining similar keyframes having a similarity greater than or equal to a threshold between the user image information and the keyframe list information; determining candidate keyframes from the similar key frames, the candidate keyframes having geometrically similar co-relationships with the user image information ; generating user position estimation information based on co-relationships of 3D point information of the determined candidate keyframes and 2D point information of the user image information; and controlling the robot to move to an estimated user position based on the user position estimation information.
